(19) United States
(12) Patent Application Publication
(10) Pub. No.: US 2017/0247804 A1
(43) Pub. Date: Aug. 31, 2017

(54) ELECTROCHEMICAL REACTION DEVICE AND ELECTROCHEMICAL REACTION METHOD

(71) Applicant: Kabushiki Kaisha Toshiba, Minato-ku (JP)

(72) Inventors: Arisa YAMADA, Kawasaki (JP); Satoshi Mikoshiba, Yamato (JP); Akihiko Ono, Kita (JP); Yuki Kudo, Yokohama (JP); Jun Tamura, Chuo (JP); Ryota Kitagawa, Setagaya (JP); Eishi Tsutsumi, Kawasaki (JP); Masakazu Yamagiwa, Yokohama (JP); Yoshitsune Sugano, Kawasaki (JP); Asahi Motoshige, Yokohama (JP)

(73) Assignee: Kabushiki Kaisha Toshiba, Minato-ku (JP)

(21) Appl. No.: 15/263,546

(22) Filed: Sep. 13, 2016

(30) Foreign Application Priority Data
Feb. 29, 2016 (JP) 2016-037254

(51) Int. Cl. C25B 15/08; H01G 9/20; C25B 1/00; C25B 9/06; C25B 3/04; C25B 1/04

(52) U.S. Cl. CPC C25B 15/08; C25B 3/04; C25B 1/04; C25B 1/003; C25B 9/06; H01G 9/20

(57) ABSTRACT

A electrochemical reaction device of an embodiment includes: an electrolytic tank storing an electrolytic solution containing water; a fine bubble supply part which supplies fine bubbles containing carbon dioxide into the electrolytic solution; a reduction electrode which is immersed in the electrolytic solution and reduces the carbon dioxide to generate a carbon compound; an oxidation electrode which is immersed in the electrolytic solution and oxidizes the water to generate oxygen; and a photoelectric conversion body electrically connected to the reduction electrode and the oxidation electrode. The fine bubbles have a floating velocity of 10 mm/s or less in the electrolytic solution under an atmospheric pressure and 20° C. condition.

### CROSS-REFERENCE TO RELATED APPLICATION

This application is based upon and claims the benefit of priority from Japanese Patent Application No. 2016-037254, filed on Feb. 29, 2016; the entire contents of which are incorporated herein by reference.

### FIELD

Embodiments described herein generally relate to an electrochemical reaction device and an electrochemical reaction method.

### BACKGROUND

Artificial photosynthesis technology that replicates photosynthesis of plants to artificially produce a storable chemical energy source from solar energy has been drawing attention from viewpoints of an energy problem and an environmental problem. A photoelectrochemical reaction device that realizes the artificial photosynthesis technology includes, for example, a photoelectric conversion layer using a semiconductor, an oxidation reaction electrode that oxidizes water (H₂O) to generate oxygen O₂, and a reduction reaction electrode that reduces carbon dioxide (CO₂) to generate a carbon compound. In such a photoelectrochemical reaction device, the oxidation reaction electrode and the reduction reaction electrode which are electrically connected to the photoelectric conversion layer are immersed in water in which CO₂ is dissolved, to cause a reduction reaction of CO₂.

The oxidation reaction electrode has, for example, a structure in which an oxidation catalyst which oxidizes H₂O is provided on the surface of a photocatalyst, and obtains a potential when given light energy. The reduction reaction electrode has, for example, a structure in which a reduction catalyst which reduces CO₂ is provided on the surface of a photocatalyst, and is electrically connected to the oxidation reaction electrode. The reduction reaction electrode obtains a CO₂ reduction potential from the oxidation reaction electrode, thereby reducing CO₂ to generate a carbon compound such as carbon monoxide (CO), formic acid (HCOOH), methanol (CH₃OH), methane (CH₄), ethanol (C₂H₅OH), or ethane (C₂H₆).

In the conventional photoelectrochemical reaction device, solar energy conversion efficiency is about 0.04% and thus is very low. There has also been a proposal to use GaN as a photoelectric conversion layer, perform photoelectric conversion, oxidize H₂O by an oxidation reaction electrode provided on the surface of the photoelectric conversion layer, and reduce CO₂ by a reduction reaction electrode formed of a copper plate and electrically connected to the photoelectric conversion layer. This, however, has achieved only low solar energy conversion efficiency of about 0.2%. One possible reason why reaction efficiency of the photoelectrochemical reaction is low is low CO₂ supply efficiency. It is known that CO₂ is a stable substance and an overvoltage of its reduction reaction is high. Further, while raw materials except CO₂ used for the oxidation reaction of water and the reduction reaction of CO₂ are liquid-based, only CO₂ is gas and thus is difficult to dissolve in an electrolytic solution such as water. The low CO₂ supply efficiency makes it difficult to enhance the photoelectrochemical reaction efficiency.

### BRIEF DESCRIPTION OF THE DRAWINGS

FIG. 1 is a view illustrating a photoelectrochemical reaction device according to a first embodiment.

FIG. 2 is a cross-sectional view illustrating a structure example of a photoelectrochemical cell used in the photoelectrochemical reaction device illustrated in FIG. 1.

FIG. 3 is a view illustrating a first modification example of the photoelectrochemical reaction device according to the first embodiment.

FIG. 4 is a view illustrating a second modification example of the photoelectrochemical reaction device according to the first embodiment.

FIG. 5 is a view illustrating a third modification example of the photoelectrochemical reaction device according to the first embodiment.

FIG. 6 is a view illustrating a photoelectrochemical reaction device according to a second embodiment.

### DETAILED DESCRIPTION

According to one embodiment, there is provided a electrochemical reaction device including: an electrolytic tank storing an electrolytic solution containing water; a bubble supply part which supplies bubbles containing carbon dioxide into the electrolytic solution; a reduction electrode which is immersed in the electrolytic solution and reduces the carbon dioxide to generate a carbon compound; an oxidation electrode which is immersed in the electrolytic solution and oxidizes the water to generate oxygen; and a photoelectric conversion body connected to the reduction electrode and the oxidation electrode. In the electrochemical reaction device of the embodiment, the bubbles have a floating velocity of 10 mm/s or less in the electrolytic solution under an atmospheric pressure and 20° C. condition.

Photoelectrochemical reaction devices of embodiments will be hereinafter described with reference to the drawings. In the embodiments, substantially the same constituent elements are denoted by the same reference signs and a description thereof will be omitted in some case. The drawings are schematic, and a relation of the thickness and the planar dimension of each part, a thickness ratio among parts, and so on may differ from actual ones.

### First Embodiment

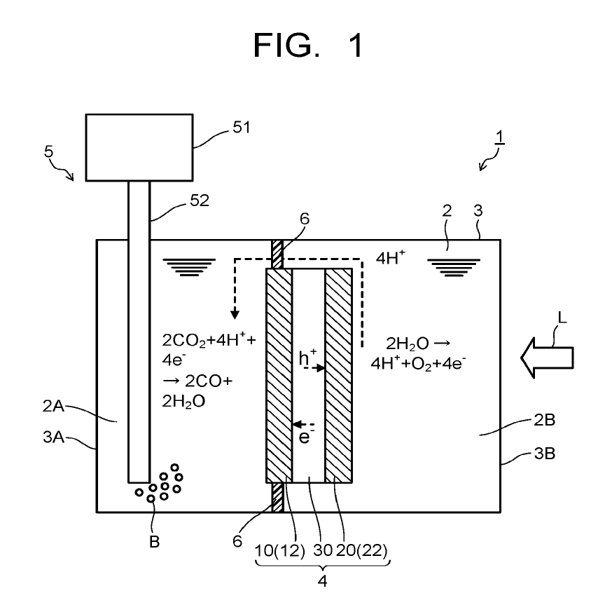

FIG. 1 is a view illustrating a photoelectrochemical reaction device 1 according to a first embodiment. The photoelectrochemical reaction device 1 illustrated in FIG. 1 includes: an electrolytic tank 3 storing an electrolytic solution 2 containing water (H₂O); a photoelectrochemical cell 4 immersed in the electrolytic solution 2; and a fine bubble supply part 5 which supplies fine bubbles containing carbon dioxide (CO₂) into the electrolytic solution 2. The photoelectrochemical cell 4 includes a reduction electrode 10, an oxidation electrode 20, and a photoelectric conversion layer 30 sandwiched by the reduction electrode 10 and the oxidation electrode 20, and they are all immersed in the electrolytic solution 2.

The electrolytic tank 3 is divided into two chambers by the photoelectrochemical cell 4 and an ion migration layer (ion migration layer serving also as a separation wall) 6 allowing ions to migrate therethrough. The electrolytic tank 3 divided into the two chambers includes a first storage part 3A storing a first electrolytic solution 2A in which the reduction electrode 10 of the photoelectrochemical cell 4 is immersed and a second storage part 3B storing a second electrolytic solution 2B in which the oxidation electrode 20 of the photoelectrochemical cell 4 is immersed. The reduction electrode 10 and the oxidation electrode 20 of the photoelectrochemical cell 4 are in contact with the first electrolytic solution 2A and the second electrolytic solution 2B respectively, and the photoelectrochemical cell 4 and the ion migration layer 6 separate the first electrolytic solution 2A and the second electrolytic solution 2B. The electrolytic tank 3 may have a gas exhaust pipe, a solution conduit, a solution discharge pipe, and so on, which are not illustrated.

The ion migration layer 6 is formed of an ion exchange membrane or the like allowing ions to migrate therethrough between the reduction electrode 10 and the oxidation electrode 20 and capable of separating the first electrolytic solution 2A and the second electrolytic solution 2B. As the ion exchange membrane, a cation exchange membrane such as Nafion or Flemion or an anion exchange membrane such as Neosepta or Selemion is usable, for instance. For example, the cation exchange membrane is used to allow the migration of hydrogen ions (H⁺), and the anion exchange membrane is used to allow the migration of hydroxide ions (OH⁻). Any other material allowing the ion migration between the reduction electrode 10 and the oxidation electrode 20 is usable as the ion migration layer 6. Whether to install the ion migration layer 6 or not is optional, but the ion migration layer 6 is preferably installed in view of increasing a difference in hydrogen ion concentration between the first electrolytic solution 2A and the second electrolytic solution 2B.

The first electrolytic solution 2A is preferably a solution having a high carbon dioxide (CO₂) absorptance, and its example is a solution containing water (H₂O). The second electrolytic solution 2B is a solution containing at least water (H₂O). As the first electrolytic solution 2A and the second electrolytic solution 2B, the same solution may be used or different solutions may be used. As the solutions containing H₂O being the first and second electrolytic solutions 2A, 2B, aqueous solutions each containing a desired electrolyte are used, for instance. Examples of the solution having the high CO₂ absorptance include aqueous solutions of LiHCO₃, NaHCO₃, KHCO₃, CsHCO₃, Li₂CO₃, Na₂CO₃, or K₂CO₃. These aqueous solutions may each contain the following electrolytes for adjusting electrical conductivity or the like.

Examples of the electrolytes contained in the electrolytic solutions 2A, 2B include phosphoric acid ions (PO₄²⁻), boric acid ions (BO₃³⁻), carbonate ions (CO₃²⁻), hydrogen carbonate ions (HCO₃⁻), lithium ions (Li⁺), sodium ions (Na⁺), potassium ions (K⁺), cesium ions (Cs⁺), calcium ions (Ca²⁺), magnesium ions (Mg²⁺), fluoride ions (F⁻), chloride ions (Cl⁻), bromide ions (Br⁻), iodide ions (I⁻), BF₄⁻, PF₆⁻, CF₃COO⁻, CF₃SO₃⁻, NO₃⁻, SCN⁻, and (CF₃SO₂)₃C⁻. The electrolytes contained in the electrolytic solutions 2A, 2B each may contain one component or may contain a plurality of components mixed at an optional ratio.

For the electrolytic solutions 2A, 2B, organic solvents such as methanol, ethanol, or acetone may be used. Alternatively, the electrolytic solutions 2A, 2B each may be an ionic liquid which is made of salts of cations such as imidazolium ions or pyridinium ions and anions such as BF₄⁻ or PF₆⁻ and which is in a liquid state in a wide temperature range, or may be its aqueous solution. Other examples of the electrolytic solutions include solutions of amines such as ethanolamine, imidazole, and pyridine, or aqueous solutions thereof. The amine may be any of primary amine, secondary amine, and tertiary amine.

The fine bubble supply part 5 includes a fine bubble generating part 51 which generates the fine bubbles containing carbon dioxide (CO₂) and a fine bubble supply pipe 52 which supplies the fine bubbles generated by the fine bubble generating part 51 into the first electrolytic solution 2A in which the reduction electrode 10 is immersed. The fine bubbles containing CO₂ are supplied as, for example, a gas-liquid two-phase flow. The fine bubbles B supplied from the fine bubble supply pipe 52 only need to contain CO₂, and the gas contained therein is not limited to gas of only CO₂ but may be the air or the like. For convenience sake, FIG. 1 illustrates a state where the fine bubble generating part 51 is installed outside the electrolytic tank 3 and the electrolytic solution containing the fine bubbles generated by the fine bubble generating part 51 is supplied into the first electrolytic solution 2A through the fine bubble supply pipe 52, but the structure of the fine bubble supply part 5 is not limited to this, and the fine bubble generating part 51 may be installed in the first electrolytic solution 2A and the gas containing CO₂ may be supplied to such a fine bubble generating part 51.

The fine bubbles B supplied into the first electrolytic solution 2A through the fine bubble supply pipe 52 have a floating velocity of 10 mm/s or less in the first electrolytic solution 2A under an atmospheric pressure and 20° C. condition, and a particle size as to have such a floating velocity. The floating velocity of bubbles in liquid is generally proportional to a square of the radius of the bubbles and inversely proportional to viscosity of the liquid, and thus a relation of the bubble radius and the floating velocity is not uniquely determined. However, when the bubble radius is 1 mm or less, the floating velocity also tends to increase as the bubble radius increases, irrespective of the viscosity of the liquid. That is, as the floating velocity is smaller, the bubble radius is smaller. The electrolytic solution 2A is generally an aqueous solution, and the viscosity of the electrolytic solution 2A approximates the viscosity of water. Accordingly, when the floating velocity is 10 mm/s or less, the particle size of the fine bubbles is 50 μm or less. Consequently, the fine bubbles containing CO₂ have a large specific surface area with respect to the electrolytic solution 2A and stay long in the electrolytic solution 2A. This is advantageous in improving a dissolution velocity of CO₂ in the electrolytic solution 2A. That is, the CO₂ concentration in the electrolytic solution 2A can be increased.

The fine bubbles are bubbles having a fine particle size and generally include bubbles called microbubbles having a 50 μm particle size or less, micronanobubbles having a 10 μm particle size or less, and nanobubbles having a 1 μm particles size or less. In the photoelectrochemical reaction device 1 of the embodiment, the fine bubbles B which have such a particles size as to have the 10 mm/s floating velocity or less in the first electrolytic solution 2A under the atmospheric pressure and 20° C. condition, for example, have a 50 μm particles size or less are used. As long as the fine bubbles B satisfy this condition, other conditions such as the viscosity of the liquid are not limited to particular values. Further, if the fine bubbles B have a nanometer size or less, the gas becomes transparent and thus light transmittance improves. Accordingly, even in a case where the photoelectric conversion layer 30 of the photoelectrochemical cell 4 is disposed in the electrolytic solution 2A, the fine bubbles B having a 1 μm particle size or less prevent the electrolytic solution 2A from lowering light radiation efficiency to the photoelectric conversion layer 30 and can increase the light radiation efficiency to the photoelectric conversion layer 30.

The floating velocity of the bubbles refers to a velocity when the bubbles float up at a uniform velocity. In the measurement of the floating velocity of the bubbles, the bubbles are generated in a solution tank under the atmospheric pressure and 20° C. condition, light is radiated to the bubbles to be scattered, and a floating velocity of a most front bubble group among the bubbles rising in the solution tank (terminal floating velocity) is measured. For the measurement of the concentration and size of the bubbles, a laser diffraction scattering method or an electrical resistance method with a Coulter counter can be employed.

As the fine bubble generating part 51, a fine bubble generator of a shock wave (crushing) type which generates fine bubbles using a sharp pressure change caused by a shock wave, of a spiral flow type which shears the gas-liquid two-phase flow by a spiral flow to turn it into fine bubbles, or the like is usable, for instance. Examples of other usable fine bubble generating means include a pore (filter) type (method to convert normal bubbles into fine bubbles by using a filter having pores with the same diameter as the diameter of the intended fine bubbles), a pressure dissolution type (method to convert normal bubbles to fine bubbles by pressurizing water containing the normal bubbles), a shearing type (method to generate fine bubbles by the application of a mechanical shear force of a waterjet or the like), and an ultrasonic type (method to generate fine bubbles by supplying gas from a thin needlepoint into water of an ultrasonic field). A microbubble producing apparatus not consuming power like, for example, the apparatus described in Japanese Patent Application Laid-open No. 2003-305494 is suitably used as the fine bubble generating part 51.

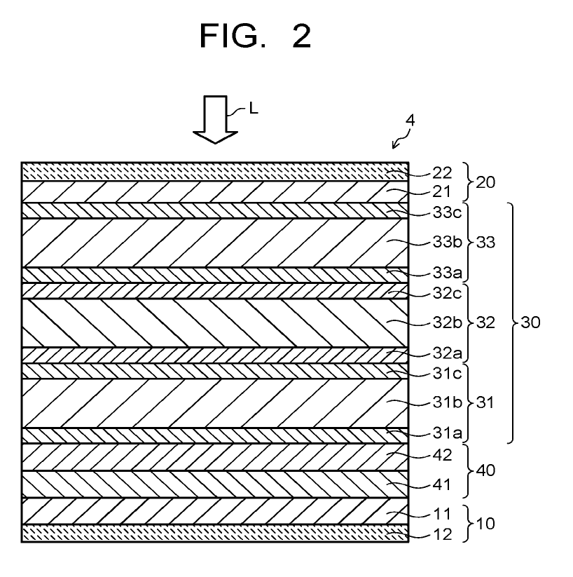

A specific example of the photoelectrochemical cell 4 will be described with reference to FIG. 2. The photoelectrochemical cell 4 whose light receiving surface (incident surface of light L) is the oxidation electrode 20 will be described here. The photoelectrochemical cell 4 illustrated in FIG. 2 includes a reflective layer 40, the photoelectric conversion layer 30, and the oxidation electrode 20 which are stacked integrally on a substrate 11 constituting part of the reduction electrode 10. A relation of polarity of the photoelectric conversion layer 30 and the arrangement of the substrate 11 may be any. In FIG. 2, the oxidation electrode 20 is disposed on the light incident surface side, but in a case where the polarity of the photoelectric conversion layer 30 is reversed, the reduction electrode 10 is disposed on the light incident surface side. That is, in the photoelectrochemical cell 4, in the case where the polarity of a solar cell constituting the photoelectric conversion layer 30 is reversed, the positions of the oxidation electrode 20 and the reduction electrode 10 are interchanged. At least one of the reduction electrode 10 and the oxidation electrode 20 desirably has transparency.

In the photoelectrochemical cell 4 illustrated in FIG. 2, a reduction catalyst layer 12 is provided on a surface, of the substrate 11, opposite to the surface where the photoelectric conversion layer 30 and the oxidation electrode 20 are stacked. The substrate 11 constitutes part of the reduction electrode 10 and in addition is provided to support the photoelectrochemical cell 4 to increase its mechanical strength. The substrate 11 has electrical conductivity and is formed of, for example, a metal plate of Cu, Al, Ti, Ni, Fe, Ag, or the like or an alloy plate containing at least one of the above metals, for example SUS plate. The substrate 11 may be formed of a conductive resin or the like such as an ion exchange membrane, or may be a semiconductor substrate of Si, Ge, or the like.

The reduction catalyst layer 12 is formed on the rear surface side of the substrate 11. The reduction catalyst layer 12 is disposed on a negative electrode side of the photoelectric conversion layer 30 and reduces CO₂ to generate a carbon compound such as carbon monoxide (CO). The reduction catalyst layer 12 is formed of a material which reduces activation energy for reducing CO₂. In other words, it is formed of a material which lowers an overvoltage of the CO₂ reduction for generating the carbon compound. Examples of such a material include metals such as Au, Ag, Cu, Pt, Ni, Zn, and Pd, an alloy containing at least one of these metals, metal complexes such as a Ru complex, and carbon materials such as C, graphene, CNT (carbon nanotube), fullerene, and ketjen black. The form of the reduction catalyst layer 12 is not limited to a thin film form but may be a lattice form, a granular form, or a wire form.

In the reduction electrode 10, a conductive porous layer may be provided. The presence of the conductive porous layer facilitates the supply of CO₂ to a reduction catalyst. Examples of the reduction electrode layer 10 having the porous layer include a structure in which the surface of the porous layer carries the aforesaid metal fine particles, metal complex, or the like. Alternatively, the metal fine particles, the metal complex, or the like may be formed on a metal porous body. The porous body preferably has the distribution of 5 to 100 nm size pores. This can increase catalytic activity. As such a porous body, a combination of porous substances having different pore sizes is suitable for improving a surface area, substance diffusion, electrical conductivity, and ion diffusion. That is, as the pore distribution for achieving all the surface area, substance diffusion, electrical conductivity, and ion diffusion, the porous body preferably has the distribution of a plurality of pore sizes. For example, providing metal porous substances or fine particles with several nm to several 10 nm on the conductive porous layer having the distribution of several μm-order pores improves performance.

Further, working the surface of the reduction catalyst layer 12 into a 5 μm rugged shape or less remarkably increases a reaction area to improve catalytic performance, leading to improved total efficiency. The use of a nano-sized catalyst can lower the overvoltage of the CO₂ reduction and can widen selectivity of a reaction product. For example, when a catalyst with a gold nanoparticle structure which is generated through an electrochemical reduction of a nanostructure formed through high-frequency oxidation of the surface of gold is used, Co is mainly generated as the reduction product of CO₂ in a region where the overvoltage is low. When a catalyst with a gold nanoporous structure which is generated through the reduction of a nanostructure formed on the gold surface by anodic oxidation is used, it is possible to increase a surface area to increase a reaction amount.

In the photoelectrochemical cell 4 illustrated in FIG. 2, the reflective layer 40 and the photoelectric conversion layer 30 are formed on the substrate 11. The photoelectric conversion layer 30 includes a first photoelectric conversion layer 31, a second photoelectric conversion layer 32, and a third photoelectric conversion layer 33. The reflective layer 40 includes a first reflective layer 41 and a second 42 formed on the surface of the substrate 11. The first reflective layer 41 is formed of a material capable of light reflection and is, for example, a distributed Bragg reflection layer composed of metal layers or a semiconductor multilayer film. Owing to the presence of the first reflective layer 41 between the substrate 11 and the photoelectric conversion layer 30, light that cannot be absorbed by the photoelectric conversion layer 30 is reflected to enter the photoelectric conversion layer 30 again. This can improve light absorptance in the photoelectric conversion layer 30.

The second reflective layer 42 is disposed between the first reflective layer 41 and the first photoelectric conversion layer 31. Accordingly, the second reflective layer 42 is preferably formed of a material capable of ohmic contact with a contact surface of the first photoelectric conversion layer 31. The second reflective layer 42 is formed of, for example, a metal such as Ag, Au, Al, Pd, Sn, Bi, or Cu, or an alloy containing at least one of these metals. The second reflective layer 42 may be formed of a transparent conductive oxide such as ITO (indium tin oxide), zinc oxide (ZnO), FTO (fluorine-doped tin oxide), AZO (aluminum-doped zinc oxide), or ATO (antimony-doped tin oxide). The second reflective layer 42 may have, for example, a stacked structure of the metal and the transparent conductive oxide, a composite structure of the metal and another conductive material, or a composite structure of the transparent conductive oxide and another conductive material.

The first to third photoelectric conversion layers 31 to 33 are each a solar cell. The use of a multijunction solar cell composed of the plural solar cells stacked on the substrate 11 as illustrated in FIG. 2 makes it possible to obtain a voltage equal to or more than a potential difference between the oxidation of water and the reduction of CO₂ in a planar structure, enabling a simple monolithic structure to cause a reaction without a need for complicated wiring or the like. Further, the two dimensional assembly of solar cells different in absorption wavelength as will be described later makes it possible to use energy of sunlight with less waste to easily improve reaction efficiency.

In the first to third photoelectric conversion layers 31 to 33, charge separation is caused by lights in respective wavelength ranges. That is, holes and electrons are separated to a positive electrode side (front surface side) and to a negative electrode side (rear surface side) respectively. Consequently, the photoelectric conversion layer 30 generates an electromotive force. The structure of each of the photoelectric conversion layers 31 to 33 is as follows. The first photoelectric conversion layer 31 formed on the reflective layer 40 has an n-type amorphous silicon (a-Si) layer 31a, an intrinsic a-Si layer 31b, and a p-type microcrystalline silicon (μc-Si) layer 31c which are stacked in order from the lower side. The a-Si layer 31b is a layer that absorbs light in a long wavelength range of about 700 nm. In the first photoelectric conversion layer 31, charge separation is caused by energy of light in the long wavelength range.

The second photoelectric conversion layer 32 formed on the first photoelectric conversion layer 31 has an n-type a-Si layer 32a, an intrinsic a-SiGe layer 32b, and a p-type μc-Si layer 32c which are stacked in order from the lower side. The a-SiGe layer 32b absorbs light in an intermediate wavelength range of about 600 nm. In the second photoelectric conversion layer 32, charge separation is caused by energy of light in the middle wavelength range. The third photoelectric conversion layer 33 formed on the second photoelectric conversion layer 32 has an n-type a-Si layer 33a, an intrinsic amorphous silicon germanium (a-SiGe) layer 33b, and a p-type μc-Si layer 33c which are stacked in order from the lower side. The a-SiGe layer 33b absorbs light in a short wavelength range of about 400 nm. In the third photoelectric conversion layer 33, charge separation is caused by energy of light in the short wavelength range.

The above describes the photoelectric conversion layer 30 has the stacked structure of the three solar cells as an example, but the structure of the photoelectric conversion layer 30 is not limited to this. The photoelectric conversion layer 30 may be a single photoelectric conversion layer (solar cell) or may have a stacked structure of two, or four or more photoelectric conversion layers (solar cells). Further, the photoelectric conversion layer 30 is not limited to the solar cell using the pin junction semiconductor, but may be a solar cell using a pn-junction semiconductor. The semiconductor layers forming the solar cells are not limited to those of Si and Ge, but compound semiconductors such as GaAs, GaInP, AlGaInP, CdTe, and CuInGaSe may be used, for instance. As the semiconductors, any of various forms such as monocrystalline, polycrystalline, and amorphous forms is usable.

An oxidation electrode layer 21 is formed on the photoelectric conversion layer 30. Accordingly, the oxidation electrode layer 21 is preferably formed of a material capable of ohmic contact with a contact surface of the photoelectric conversion layer 30. The oxidation electrode layer 21 is formed of a metal such as Ag, Au, Al, or Cu, an alloy containing at least one of these metals, or a transparent conductive oxide such as ITO, ZnO, FTO, AZO, or ATO, for instance. The oxidation electrode layer 21 may have, for example, a stacked structure of the metal and the transparent conductive oxide, a composite structure of the metal and another conductive material, or a composite structure of the transparent conductive oxide and another conductive material, for instance. In the photoelectrochemical cell 4 illustrated in FIG. 2, irradiating light L passes through the oxidation electrode layer 21 to reach the photoelectric conversion layer 30. This necessitates the oxidation electrode layer 21 disposed on the light irradiated surface side to have a light transmittance property for the irradiating light L. The light transmittance of the oxidation electrode layer 21 on the light irradiated surface side is preferably at least 10% or more, more preferably 30% or more, of an irradiation amount of the irradiating light L.

An oxidation catalyst layer 22 is formed on the oxidation electrode layer 21. The oxidation catalyst layer 22 is disposed on the positive electrode side of the photoelectric conversion layer 30 and oxidizes H₂O to generate O₂ and H⁺. Accordingly, the oxidation catalyst layer 22 is formed of a material which reduces activation energy for oxidizing H₂O. In other words, it is formed of a material which lowers an overvoltage of the H₂O oxidation for generating O₂ and H⁺. Examples of such a material include binary metal oxides such as manganese oxide (Mn—O), iridium oxide (Ir—O), nickel oxide (Ni—O), cobalt oxide (Co—O), iron oxide (Fe—O), tin oxide (Sn—O), indium oxide (In—O), and ruthenium oxide (Ru—O), ternary metal oxides such as Ni—Co—O, La—Co—O, Ni—La—O, Sr—Fe—O, and Ni—Fe—O, and quaternary metal oxides such as Pb—Ru—Ir—O and La—Sr—Co—O, and metal complexes such as a Ru complex. A single element of any of these or a mixture of these may be used. The form of the oxidation catalyst layer 22 is not limited to a thin film form, and may be a lattice form, a granular form, a wire form, or the like. Examples of its fabrication method include an electrodeposition method, a sputtering method, a vapor deposition method, and an ALD (atomic layer deposition) method.

In the photoelectrochemical cell 4 illustrated in FIG. 2, a protection layer may be disposed between the oxidation electrode layer 21 and the oxidation catalyst layer 22 or between the oxidation electrode layer 21 and the photoelectric conversion layer 30. The protection layer has electrical conductivity and prevents corrosion of the photoelectric conversion layer 30 in the oxidation-reduction reaction. The protection layer preferably has both the function as the protection layer and a function of ion isolation. This as a result can extend the life of the photoelectric conversion layer 30. The protection layer has a light transmittance property as required. Examples of the protection layer include dielectric thin films of TiO₂, ZrO₂, Al₂O₃, SiO₂, and HfO₂. The film thickness of the protection layer is preferably 10 nm or less, more preferably 5 nm or less in order to obtain electrical conductivity due to a tunnel effect.

The photoelectrochemical cell 4 used in the photoelectrochemical reaction device 1 of the embodiment is not limited to a stack in which the reduction electrode 10 composed of the substrate 11 and the reduction catalyst layer 12, the reflective layer 40, the photoelectric conversion layer 30, and the oxidation electrode 20 composed of the oxidation electrode layer 21 and the oxidation catalyst layer 22 are stacked in sequence as illustrated in FIG. 2. The photoelectrochemical cell 4 illustrated in FIG. 2 has the integrated structure, which is immersed in the electrolytic solution 2, but is not limited to this structure. In the photoelectrochemical cell 4, as long as the photoelectric conversion layer 30 is electrically connected to the reduction electrode 10 having the reduction catalyst layer 12 and the oxidation electrode 20 having the oxidation catalyst layer 22, an arrangement place of the photoelectric conversion layer 30 may be any.

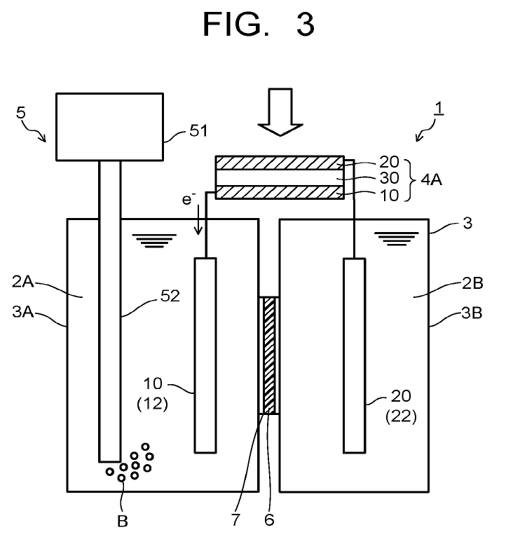

FIG. 3 illustrates a structure in which a photoelectrochemical cell 4A is disposed outside the electrolytic tank 3, and this photoelectrochemical cell 4A is electrically connected to the reduction electrode 10 having the reduction catalyst layer 12 and immersed in the first electrolytic solution 2A and to the oxidation electrode 20 having the oxidation catalyst layer 22 and immersed in the second electrolytic solution 2B. The photoelectrochemical cell 4A illustrated in FIG. 3 has the same structure as the photoelectrochemical cell 4 illustrated in FIG. 2 except the reduction catalyst layer 12 and the oxidation catalyst layer 22. In the electrolytic tank 3 illustrated in FIG. 3, the first storage part 3A storing the first electrolytic solution 2A and the second storage part 3B storing the second electrolytic solution 2B are connected via a connection part 7, and the ion migration layer 6 is disposed in the connection part 7.

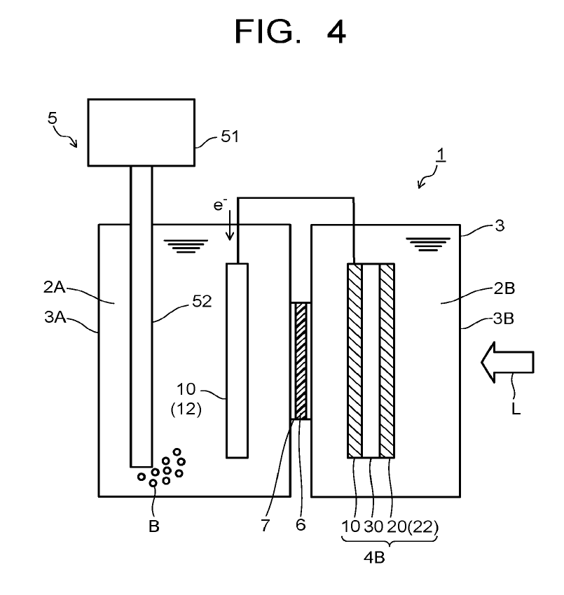

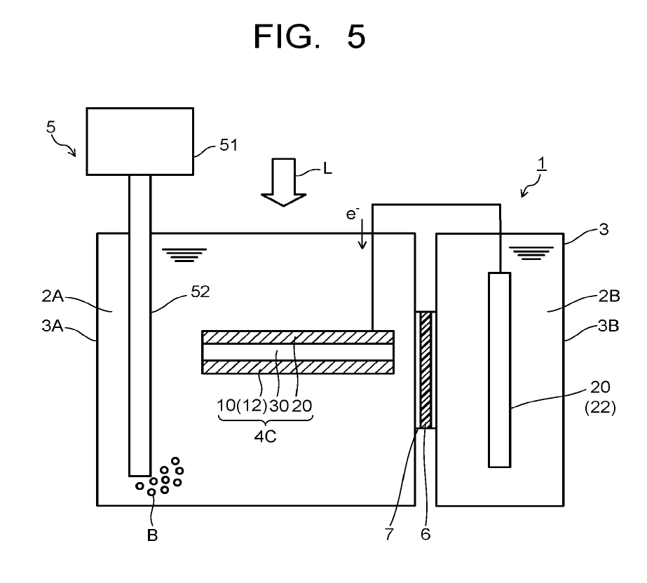

FIG. 4 illustrates a structure in which the reduction electrode 10 having the reduction catalyst layer 12 is immersed in the first electrolytic solution 2A, a photoelectrochemical cell 4B having the oxidation catalyst layer 22 is immersed in the second electrolytic solution 2B, and an electrode (negative electrode) 10 of the photoelectrochemical cell 4B is electrically connected to the reduction electrode 10 having the reduction catalyst layer 12 and immersed in the first electrolytic solution 2A. The photoelectrochemical cell 4B illustrated in FIG. 4 has the same structure as the photoelectrochemical cell 4 illustrated in FIG. 2 except the reduction catalyst layer 12. FIG. 5 illustrates a structure in which a photoelectrochemical cell 4C having the reduction catalyst layer 12 is immersed in the first electrolytic solution 2A, the oxidation electrode 20 having the oxidation catalyst layer 22 is immersed in the second electrolytic solution 2B, and an electrode (positive electrode) 20 of the photoelectrochemical cell 4C is electrically connected to the oxidation electrode 20 having the oxidation catalyst layer 22 and immersed in the second electrolytic solution 2B. The photoelectrochemical cell 4C illustrated in FIG. 5 has the same structure as the photoelectrochemical cell 4 illustrated in FIG. 2 except the oxidation catalyst layer 22.

In the structure examples illustrated in FIG. 1 and FIG. 4, the irradiating light L passes through the oxidation electrode layer 21 and the oxidation catalyst layer 22 to reach the photoelectric conversion layer 30. Accordingly, the oxidation catalyst layer 22 disposed on the light irradiated surface side has the light transmittance property for the irradiating light L. More specifically, the light transmittance of the oxidation catalyst layer 22 on the light irradiated surface side is preferably 10% or more, more preferably 30% or more, of an irradiation amount of the irradiating light L. In the structure examples in FIG. 3 and FIG. 5, the oxidation catalyst layer 22 need not have the light transmittance property, and its shape is not limited at all. In the structure examples in FIG. 3 and FIG. 5, only the front surface-side electrode 20 needs to have the light transmittance property. Further, the sizes and shapes of the reduction catalyst layer 12, the substrate 11, the photoelectric conversion layer 30, and the oxidation catalyst layer 22 are not limited to particular ones. They may have flat plate shapes with the same area or may be different in size or shape.

Next, the operation of the photoelectrochemical reaction device 1 of the embodiment will be described with reference to FIG. 1. When the light L enters, the incident light L passes through the oxidation catalyst layer 22 and the oxidation electrode layer 21 constituting the oxidation electrode 20 to reach the photoelectric conversion layer 30. When the photoelectric conversion layer 30 absorbs the light, it generates photoexcited electrons and holes making a pair therewith and separate them from each other. That is, the photoexcited electrons migrate to the n-type semiconductor layer (reduction catalyst layer 12) side, and the holes generated as a pair with the photoexcited electrons migrate to the p-type semiconductor layer (oxidation catalyst layer 22) side in the first to third photoelectric conversion layers illustrated in FIG. 2. Consequently, the electromotive force is generated in the photoelectric conversion layer 30.

The photoexcited electrons thus generated in the photoelectric conversion layer 30 are used for the reduction reaction in the reduction catalyst layer 12 which is the negative electrode, and the holes are used in the oxidation reaction in the oxidation catalyst layer 22 which is the positive electrode. Consequently, a reaction of the formula (1) occurs near the oxidation catalyst layer 22 and a reaction of the formula (2) occurs near the reduction catalyst layer 12.

2H₂O→4H⁺+O₂+4e⁻ (1)

2CO₂+4H⁺+4e⁻→2CO+H₂O (2)

Near the oxidation catalyst layer 22, H₂O is oxidized (loses electrons), so that O₂ and H⁺ are generated as expressed by the formula (1). H⁺ generated in the oxidation catalyst layer 22 side migrates to the reduction catalyst layer 12 side through the ion migration layer 6. Near the reduction catalyst layer 12, CO₂ and H⁺ which has migrated react with each other, so that, for example, carbon monoxide (CO) and H₂O are generated as expressed by the formula (2). That is, CO₂ is reduced (obtains electrons).

At this time, the photoelectric conversion layer 30 needs to have an open-circuit voltage equal to or larger than a potential difference between a standard oxidation-reduction potential of the oxidation reaction occurring in the oxidation catalyst layer 22 and a standard oxidation-reduction potential of the reduction reaction occurring in the reduction catalyst layer 12. For example, the standard oxidation-reduction potential of the oxidation reaction in the formula (1) is 123 [V], and the standard oxidation-reduction potential of the reduction reaction in the formula (2) is −0.1 [V]. Therefore, the open-circuit voltage of the photoelectric conversion layer 30 needs to be 1.33 [V] or more. The open-circuit voltage is more preferably equal to or more than the sum of the potential difference and overvoltages. For example, when the overvoltages of the oxidation reaction in the formula (1) and the reduction reaction in the formula (2) are both 0.2 [V], the open-circuit voltage is desirably 1.73 [V] or more.

The aforesaid CO as the reduction product of CO₂ is an example, and the reduction product is not limited to this. Near the reduction catalyst layer 12, it is possible to cause not only the reduction reaction from CO₂ to CO expressed by the formula (2) but also a reduction reaction from CO₂ to formic acid (HCOOH), methane (CH₄), ethylene (C₂H₄), methanol (CH₃OH), ethanol (C₂H₅OH), or the like. It is also possible to reduce H₂O in the first electrolytic solution 2A to generate H₂. By varying an amount of H₂O in the first electrolytic solution 2A, it is also possible to change a generated reduction product of CO₂. For example, it is possible to change a generation ratio of CO, HCOOH, CH₄, C₂H₄, CH₃OH, C₂H₅OH, H₂, and the like.

Among the aforesaid raw materials involved in the oxidation-reduction reaction expressed by the formula (1) and the formula (2), only CO₂ is gas, and the others are liquid-based. For the efficient progress of the oxidation-reduction reaction, efficient dissolution of CO₂, which is the gas, in the electrolytic solution 2A is required. For this purpose, the photoelectrochemical reaction device 1 of the embodiment includes the fine bubble supply part 5 which supplies the fine bubbles containing CO₂ into the electrolytic solution 2A. The supply of the fine bubbles containing CO₂ into the electrolytic solution 2A can greatly increase a dissolution amount of CO₂ in the electrolytic solution 2A. The fine bubbles containing CO₂ may be continuously supplied or may be intermittently supplied, during the reaction.

As previously described, the floating velocity of bubbles in liquid is generally proportional to the square of the bubble radius. That is, as the bubble radius of the fine bubbles is smaller, the floating velocity decreases and their residence time in the liquid is longer. Owing to the increase of their residence time in the liquid and the increase of their contact area with the liquid, CO₂ in the fine bubbles easily dissolves in the liquid. At this time, the fine bubbles containing CO₂ have such a particle size as to have the 10 mm/s floating velocity or less in the first electrolytic solution 2A under the atmospheric pressure and 20° C. condition, for example, have the particle size of 50 μm or less, enabling the efficient dissolution of CO₂ in the electrolytic solution 2A. Consequently, the reduction reaction of CO₂ which depends on the CO₂ dissolution amount in the electrolytic solution 2A can efficiently and continuously progress.

The reduction reaction from CO₂ to CO expressed by the formula (2) is a reaction consuming H⁺. Accordingly, a failure of H⁺ generated in the oxidation catalyst layer 22 to migrate to the reduction catalyst layer 12 which is a counter electrode lowers the whole reaction efficiency. So, the H⁺ concentration near the oxidation catalyst layer 22 and the H⁺ concentration near the reduction catalyst layer 12 in the electrolytic solution 2 are made different, and H⁺ migrates owing to this concentration difference. This improves the transport of H⁺, enabling to increase photoreaction efficiency. The ions which migrate are not limited to H⁺ but may be OH⁻. The ion migration layer 6 separating the first storage part 3A and the second storage part 3B of the electrolytic tank 3 is effective for causing the ion concentration difference. The ion migration layer 6 is formed of the ion exchange membrane or the like as previously described. Further, in order to widen the ion concentration difference, gas not containing CO₂, such as argon or nitrogen, may be bubbled in the second electrolytic solution 2B in which the oxidation catalyst layer 22 is immersed. Expelling CO₂ contained in the electrolytic solution 2B lowers the ion concentration in the electrolytic solution 2B, enabling to increase the ion concentration difference.

Regarding the installation of the ion migration layer 6 formed of the ion exchange membrane, the effect of diffusing the H⁺ ions or the like can be higher as the distance between the oxidation electrode 20 and the reduction electrode 10 is shorter, and the reaction efficiency is higher as the distance is shorter. Accordingly, the oxidation electrode 20 and the reduction electrode 10 are preferably installed to face each other, but in this case as well, some measure is required to prevent the light from being blocked. Here, it is also effective to install the light-receiving side electrode (oxidation electrode 20) perpendicularly to the incident light and install the electrode on the counter electrode side (reduction electrode 10) in parallel to the incident light (perpendicularly to the light-receiving side electrode).

It is also effective to provide a temperature regulating mechanism which regulates the temperature of the electrolytic solution, in the electrolytic tank 2 or a flow path of the electrolytic solution. By controlling the temperature of the electrolytic solution, it is possible to control photovoltaic performance and catalytic performance. For example, the temperature of a reaction system can be made uniform in order to stabilize or improve performance of the photoelectric conversion layer (solar cell) 30 and the catalysts. Further, a temperature increase can also be prevented for system stabilization. The temperature control makes it possible to change selectivity of the solar cell and the catalysts, and to also control the reaction products.

### Second Embodiment

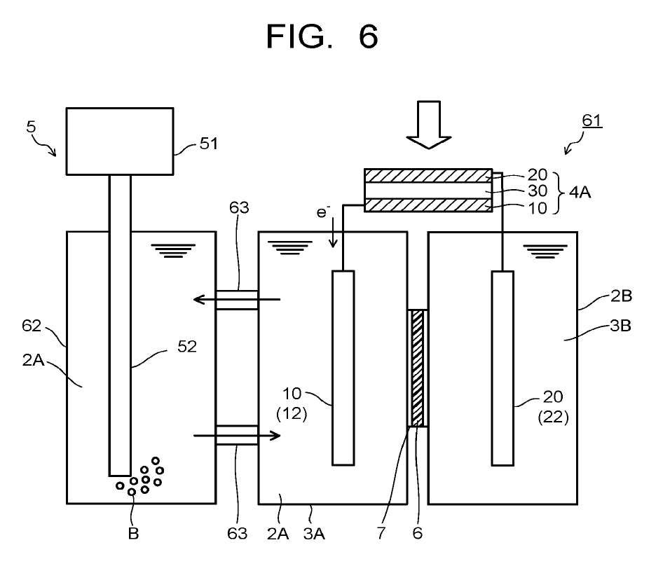

A photoelectrochemical reaction device of a second embodiment will be described with reference to FIG. 6. FIG. 6 is a view illustrating the photoelectrochemical reaction device 61 according to the second embodiment. In the photoelectrochemical reaction device 61 of the second embodiment, the same parts as those of the photoelectrochemical reaction device 1 of the first embodiment will be denoted by the same reference signs, and a description thereof will be omitted in some case. Kinds of electrolytic solutions 2A, 2B, and the structure, constituent members, and so on of a photoelectrochemical cell 4 are the same as those of the first embodiment. Incidentally, a general generator may be used instead of a photoelectrochemical cell. Examples of the generator include a system power supply, a storage battery, or the renewable energy such as wind power, water power, and the geothermal power.

The photoelectrochemical reaction device 61 illustrated in FIG. 6 includes a solution tank 62 storing an electrolytic solution 2A, in addition to the electrolytic tank 3 storing the electrolytic solutions 2A, 2B. The solution tank 62 stores the same electrolytic solution 2A as the electrolytic solution 2A in which a reduction electrode 10 is immersed. The solution tank 62 is connected to a first storage part 3A of the electrolytic tank 3 via pipes 63. In the photoelectrochemical reaction device 61 of the second embodiment, a fine bubble supply part 5 is installed in the solution tank 62. That is, CO₂-containing fine bubbles B generated in a fine bubble generating part 51 are supplied into the electrolytic solution 2A stored in the solution tank 62. Since the fine bubbles B containing CO₂ are supplied into the electrolytic solution 2A stored in the solution tank 62, CO₂ dissolves in the electrolytic solution 2A stored in the solution tank 62. The electrolytic solution 2A in which CO₂ is dissolved in the solution tank 62 is sent to the first storage part 3A of the electrolytic tank 3 via the pipe 63.

In the method of supplying the CO₂-containing fine bubbles directly to the electrolytic solution 2A stored in the first storage part 3A of the electrolytic tank 3 as described in the first embodiment, in a case where the reduction product of CO₂ is a gaseous substance such as CO, CO₂ gas which is excessively supplied in order to increase solubility and the CO gas which is the reduction product of CO₂ mix together, necessitating the separation of the CO gas from the mixed gas. Since CO₂ is supplied to and dissolved in the electrolytic solution 2A in the solution tank 62 installed separately from the electrolytic tank 3, the electrolytic solution 2A containing the previously dissolved CO₂ can be supplied to the electrolytic tank 3. This can prevent the excessively supplied CO₂ gas and the CO gas from mixing together.

When the CO₂-containing fine bubbles are supplied into the electrolytic solution 2A, an excessive amount of the fine bubbles is bubbled in order for the solubility of CO₂ to be as close to a saturated state as possible. In this case, CO₂ left undissolved in the electrolytic solution 2A floats up as gas. The solution tank 62 where CO₂ is absorbed is separately installed, and after the excessively supplied CO₂ is removed in the solution tank 62, the electrolytic solution 2A containing the dissolved CO₂ is supplied to the electrolytic tank 3, so that gas generated near the reduction electrode 10 having the reduction catalyst layer 12 in the electrolytic tank 3 is mainly CO which is the reduction product. Therefore, recovering the gas generated in the electrolytic tank 3 enables to obtain gas with a high CO concentration.

In the above-described structure, by providing an oxygen separator connected to the electrolytic solution in the oxidation-side storage part 3B of the electrolytic tank 3 via a pipe, it is possible to separate oxygen gas, similarly to CO₂. Unlike the gas separation in the electrolytic tank (cell) 3, this can recover gases generated in a plurality of cells at a time and shortens the total length of gas recovery pipes, so that the system can be simplified. In this case, for more efficient recovery of the oxygen gas, a temperature regulator may be provided in the oxygen gas separator or in the pipe between the electrolytic tank and the oxygen gas separator similarly to a CO₂ recovery device. This enables the efficient separation of oxygen from the electrolytic solution 2B.

Next, examples of the present invention and their evaluation results will be described.

### Example 1

The photoelectrochemical reaction device 1 illustrated in FIG. 4 was structured as follows. Specifically, an oxidation electrode layer and an oxidation catalyst layer were formed on a light incident surface side of a three-junction photoelectric conversion layer, and a counter electrode of the three junction photoelectric conversion layer and a reduction electrode having a reduction catalyst layer were connected by an electric wire.

As the photoelectric conversion layer, a three junction photoelectric conversion layer (thickness: 500 nm) formed of pin-type amorphous silicon (a-Si) and two kinds of pin-type amorphous silicon germanium (a-SiGe) was prepared. On one surface of the photoelectric conversion layer, an ITO electrode (thickness: 100 nm) is disposed as a transparent conductive film, and on the other surface, a ZnO electrode (thickness: 300 nm) is disposed as an electrode layer. Further, a structure in which an Ag reflective layer (thickness: 200 nm) and a SUS substrate (thickness: 1.5 mm) as a support substrate were disposed on a lower surface of the ZnO electrode was prepared. Each layer on the SUS substrate of this structure has a submicron-order texture structure for the purpose of obtaining a light confining effect.

Here, the three-junction photoelectric conversion layer is composed of a first photoelectric conversion layer, a second photoelectric conversion layer, and a third photoelectric conversion layer. The first to third photoelectric conversion layers are each a pin-junction photoelectric conversion layer (solar cell) and are different in light absorption wavelength. Two dimensionally stacking these enables the absorption of lights in a wide wavelength range of sunlight, enabling more efficient use of energy of sunlight. As a result, a high open-circuit voltage can be obtained.

Next, on an exposure portion of the ITO electrode of the above-described structure, a Ni catalyst was formed as an oxidation catalyst for water by an ALD method. The Ni catalyst layer had a 5 nm film thickness. As the reduction electrode, a composite substrate (40 mm square) in which a gold-carrying carbon (an amount of the carried gold: 0.25 mg/cm²) was pasted on a support substrate (SUS sheet with a 1.5 mm thickness) was prepared. The electric wire was connected to the rear surface of the SUS substrate of the above-described structure, and this electric wire was connected to the composite substrate as the reduction electrode. The structure having the oxidation catalyst and the reduction electrode having the reduction catalyst, which were connected by the electric wire, were disposed in an electrolytic tank. Between the oxidation electrode and the reduction electrode, an electrolyte membrane (Nafion 117) was installed to separate the oxidation electrode and the reduction electrode in an electrolytic tank.

The electrolytic tank was filled with an aqueous KHCO₃ solution with a 0.5 M concentration as an electrolytic solution. The composite substrate coated with the gold-carrying carbon was set as a reduction electrode and the structure having the electrodeposited Ni catalyst was set as an oxidation electrode, and light was radiated to the solar cell of the above-described structure to convert CO₂ to CO. For the supply of CO₂, CO₂-containing fine bubbles were directly supplied into the electrolytic solution on the reduction electrode side. At this time, the floating velocity of the fine bubbles was set to 5 mm/s. Further, the structure was irradiated with light by a solar simulator (AM1.5, 1000 W/m²), gas generated from the reduction electrode side was collected, and CO₂ conversion efficiency was measured. Light-to-CO generation efficiency η was calculated by the following formula (3). The gas was recovered on an upper portion of the reduction electrode side, and the generated gas was sampled, and was identified and quantified by gas chromatography. At the time of the measurement, an amorphous three junction solar cell was used as the solar cell, and a silver chloride electrode was used as a reference electrode. Table 1 shows the light-to-CO generation efficiency η and the Co content of the recovered gas.

η(%)={R(CO)×ΔG°}/{P×S} (3)

In the formula, R(CO) is a generation rate (mols⁻¹) of CO. ΔG° is a standard combustion Gibbs energy of CO, and CO+½O₂→CO₂, ΔG (298 K)=−257.2 kJmol⁻¹. P is solar irradiation energy, and 1 sun=AM1.5=1 kWm⁻²=0.1 Js⁻¹ cm⁻². S is a light-receiving area (cm⁻²) of the solar cell.

### Example 2

A reaction was caused in the same procedure as in the example 1 except in that fine bubbles containing CO₂ were supplied to an electrolytic solution stored in a solution tank installed separately from an electrolytic tank and the electrolytic solution containing the dissolved CO₂ was supplied to the electrolytic tank as illustrated in FIG. 6. As the fine bubbles containing CO₂, those having the same floating velocity as that in the example 1 were used. Light-to-CO generation efficiency η and the CO content of recovered gas at this time were measured as in the example 1. Table 1 shows their results.

### Comparative Example 1

A reaction was caused in the same procedure as in the example 1 except in that bubbles having a 150 mm/s floating velocity were used for the supply of CO₂ to a reduction electrode side, instead of using the fine bubbles. Light-to-CO generation efficiency η and the CO content of recovered gas at this time were measured as in the example 1. Table 1 shows their results.

TABLE 1

| | LIGHT-TO-CO | CO CONTENT |
|---|---|---|
| | GENERATION | OF |
| | EFFICIENCY | RECOVERED |
| | [%] | GAS [%] |
| EXAMPLE 1 | 3.1 | 90 |
| EXAMPLE 2 | 3.0 | 98 |
| COMPARATIVE EXAMPLE 1 | 1.5 | 53 |

As is apparent from Table 1, it is seen that the supply of CO₂ in the form of the fine bubbles improves the reaction efficiency (light-to-CO generation efficiency). It is also seen that supplying the fine bubbles containing CO₂ into the electrolytic solution and dissolving them in the electrolytic solution in the solution tank different from the electrolytic tank results in the higher content of CO in the gas recovered from the electrolytic tank to facilitate the recovery of CO.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electrochemical reaction device comprising:
an electrolytic tank storing an electrolytic solution containing water;
a bubble supply part which supplies bubbles containing carbon dioxide into the electrolytic solution;
a reduction electrode which is immersed in the electrolytic solution and reduces the carbon dioxide to generate a carbon compound;
an oxidation electrode which is immersed in the electrolytic solution and oxidizes the water to generate oxygen; and
a photoelectric conversion body connected to the reduction electrode and the oxidation electrode,
wherein the bubbles have a floating velocity of 10 mm/s or less in the electrolytic solution under an atmospheric pressure and 20° C. condition.

2. The device of claim 1,
wherein the bubbles have a particle size of 50 μm or less.

3. The device of claim 1,
wherein the bubble supply part includes a solution tank storing the electrolytic solution and a bubble generating part which supplies the bubbles to the electrolytic solution stored in the solution tank to dissolve the carbon dioxide in the electrolytic solution, and
wherein the solution tank is connected to the electrolytic tank so as to supply the electrolytic tank with the electrolytic solution in which the carbon dioxide is dissolved.

4. The device of claim 1,
wherein the electrolytic tank includes a first storage part storing a first electrolytic solution in which the reduction electrode is immersed, a second storage part storing a second electrolytic solution in which the oxidation electrode is immersed, and an ion migration body allowing ions to migrate therethrough between the first storage part and the second storage part.

5. The device of claim 4,
wherein the bubble supply part includes a bubble generating part which supplies the bubbles into the first electrolytic solution to dissolve the carbon dioxide in the first electrolytic solution.

6. The device of claim 4,
wherein the bubble supply part includes a solution tank storing the first electrolytic solution, and a bubble generating part which supplies the bubbles to the first electrolytic solution stored in the solution tank to dissolve the carbon dioxide in the first electrolytic solution, and
wherein the solution tank is connected to the first storage part so as to supply the first storage part with the first electrolytic solution in which the carbon dioxide is dissolved.

7. The device of claim 1,
wherein the bubble supply part includes a fine bubble generator employing a shock wave method, a spiral flow method, a pore method, a pressure dissolution method, a shearing method, or an ultrasonic method.

8. The device of claim 1,
wherein the photoelectric conversion body is stacked and integrated with the reduction electrode and the oxidation electrode.

9. An electrochemical reaction device comprising:
an electrolytic tank storing an electrolytic solution containing water;
a fine bubble supply part including a solution tank storing the electrolytic solution and a fine bubble generating part which supplies fine bubbles containing carbon dioxide into the electrolytic solution stored in the solution tank to dissolve the carbon dioxide in the electrolytic solution, the solution tank being connected to the electrolytic tank so as to supply the electrolytic tank with the electrolytic solution in which the carbon dioxide is dissolved;
a reduction electrode which is immersed in the electrolytic solution stored in the electrolytic tank and reduces the carbon dioxide to generate a carbon compound;
an oxidation electrode which is immersed in the electrolytic solution stored in the electrolytic tank and oxidizes the water to generate oxygen; and
a generator connected to the reduction electrode and the oxidation electrode,

10. The device of claim 9,
wherein the fine bubbles have a particle size of 50 μm or less.

11. The device of claim 9,
wherein the electrolytic tank includes a first storage part storing a first electrolytic solution in which the reduction electrode is immersed, a second storage part storing a second electrolytic solution in which the oxidation electrode is immersed, and an ion migration body allowing ions to migrate therethrough between the first storage part and the second storage part, and
wherein the solution tank is connected to the first storage part.

12. The device of claim 9,
wherein the fine bubble supply part includes a fine bubble generator employing a shock wave method, a spiral flow method, a pore method, a pressure dissolution method, a shearing method, or an ultrasonic method.

13. The device of claim 9,
wherein the generator includes a photoelectric conversion body.

14. An electrochemical reaction method comprising:
storing an electrolytic solution containing water into an electrolytic tank;
supplying bubbles containing carbon dioxide into the electrolytic solution, the bubbles having a floating velocity of 10 mm/s or less in the electrolytic solution under an atmospheric pressure and 20° C. condition;
immersing a reduction electrode and an oxidation electrode in the electrolytic solution; and
supplying electricity to the reduction electrode and the oxidation electrode to generate a carbon compound by reducing the carbon dioxide and to generate oxygen by oxidizing the water.

15. The method of claim 14,
wherein the bubbles have a particle size of 50 μm or less.

16. The method of claim 14,
wherein the bubbles supplying includes:
storing the electrolytic solution into a solution tank;
supplying the bubbles into the electrolytic solution stored in the solution tank to dissolve the carbon dioxide in the electrolytic solution; and
sending the electrolytic solution in which the carbon dioxide is dissolved from the solution tank to the electrolytic tank.

17. The method of claim 14,
wherein the bubbles are generated by a shock wave method, a spiral flow method, a pore method, a pressure dissolution method, a shearing method, or an ultrasonic method.
